(19) United States
(12) Patent Application Publication
(10) Pub. No.: US 2023/0307882 A1
(43) Pub. Date: Sep. 28, 2023

(54) COMPACT LASER HEAD

(71) Applicant: IPG PHOTONICS CORPORATION, Marlborough, MA (US)

(72) Inventors: Alexey AVDOKHIN, Southborough, MA (US); Andreas VAUPEL, Longmeadow, MA (US); Tetsuo OHARA, Acton, MA (US); Kriti CHARAN, Sutton, MA (US); Jhih-An YANG, Belchertown, MA (US)

(73) Assignee: IPG PHOTONICS CORPORATION, Marlborough, MA (US)

(21) Appl. No.: 18/021,326

(22) PCT Filed: Aug. 23, 2021
(86) PCT No.: PCT/US21/47096

§ 371 Date: Feb. 14, 2023

Related U.S. Application Data
(60) Provisional application No. 63/068,605, filed on Aug. 21, 2020.

(51) Int. Cl. H01S 3/067; G02F 1/35; H01S 3/00

(52) U.S. Cl. CPC H01S 3/06704; G02F 1/3501; H01S 3/0092; H01S 3/06712

(57) ABSTRACT

A laser head for a high power fiber laser system has a 5 to 10 mm high housing which is provided with a bottom. The housing encloses an input collimator assembly which collimates a single mode pump light at a fundamental frequency and maximum power of 2 kW. The housing further encases a multi-cascaded nonlinear frequency converter receiving the collimated pump light so as to convert the fundamental frequency into a higher harmonic thereof, wherein converted light at the higher frequency has a maximum power of 1 kW. Enclosed in the housing are electronic and light guiding optical components mounted in the housing. The bottom of the housing is an electro-optical printed circuit board (EO PCB) which directly supports the input collimator assembly, multi-cascaded nonlinear frequency converter, electronic and optical components at respective designated locations.

### BACKGROUND OF DISCLOSURE

### Filed of the Disclosure

The disclosure relates to high power lasers operating in the visible spectrum. In particular, the disclosure relates to a miniature and cost-effective laser head for the above-mentioned type of lasers.

### Background of the Disclosure

Visible light is usually defined as having wavelengths in the range between the near infrared (with longer wavelengths) and the ultraviolet (with shorter wavelengths). Industrial laser applications utilizing visible light traditionally include, but not limited to medicine, material processing, science and consumer goods. As the laser industry continues to mature with the availability of new nonlinear crystals used in frequency converting schemes, lasers generating visible light continuously find new applications, such as red green and blue (RGB) light engines.

There are several laser types outputting visible emission. One type includes short wavelength semiconductor laser diodes. Another type of the known devices is represented by various gas lasers. Still another type of solid state lasers is based on nonlinear frequency conversion which involves generating the second and higher harmonics of the fundamental frequency or utilizing sum-frequency and parametric oscillation to obtain the desired frequency. Within the scope of this invention, solid state lasers, such as fiber laser, utilizing nonlinear frequency conversion schemes are of particular interest. Yet, as one of the ordinary skill in the laser arts realizes, the main aspects of this disclosure are applicable to other solid state lasers requiring the frequency conversion.

FIG. 1 illustrates a group of fiber lasers 10 utilizing nonlinear conversion techniques. Each laser 10 includes a continuous wave (CW), quasi CW (QCW) or pulsed pump source 12 outputting infrared (IR) pump light, for example, in a 1 μm fundamental wavelength range between about 1030 and 1120 nm. The generated IR pump light further propagates through a delivery fiber 14 which is coupled to a laser head 16. The latter is configured with a frequency converter generating a visible laser output.

U.S. Pat. No. 10,008,819, which is incorporated herein in its entirety, discloses an exemplary QCW laser generating Red light at 615, 635 nm and longer wavelengths by utilizing a combination of Raman converter and frequency conversion schemes. The Raman converter includes a Raman fiber provided with the cavity which consists of one or several pairs (cascades) of fiber Bragg gratings. As known to one of ordinary skill, the Raman converter provides a wavelength shift from the fundamental frequency of the pump light within the Raman gain spectrum of the fiber. As pump light at the Raman-shifted fundamental frequency is converted into a Red output light by the frequency converter, such as a second harmonic generator (SHG) mounted to the laser head.

The laser head 16, associated with a fiber laser which operates in the visible spectral range, is the subject matter of this disclosure. Compactness, automation, cost-effectiveness, cleanliness, optical efficiency and stability with respect to mechanical and thermal loads are all essential characteristics of the laser head. Each individual characteristic is defined by one or more particular components. Often improving one of the characteristics may detrimentally affect other characteristics. Thus the improvement of the laser head's operation needs an integrated approach requiring modifications of multiple laser head components as exemplified by the following developmental history of laser head 16.

FIG. 2 illustrates exemplary laser head 16 configured to output Red light, but one of ordinary skill in the laser arts readily recognizes that the shown configuration would be relevant to any fiber laser operating in any region of the visible spectrum with or without insignificant changes. For example, the Raman converter may be omitted since the frequency generator may utilize various nonlinear effects besides SHG. For example, a nonlinear optical process may include sum frequency and other techniques determining a corresponding optical schematic as well known to one of ordinary skill in the laser arts.

The architecture of laser head 16 includes a combination of optical, fiber-related and electrical/electronic components all mounted on a bottom 18 the laser head's housing. The delivery fiber 14 extends through a fiber connector 30 into the interior of laser head 16 where the fiber's distal end is received by an input collimator assembly or objective 32.

Turning to FIG. 3 considered in light of FIG. 2, input collimator assembly 32 is provided with multiple elements one of which is an end block 34 made of quartz and fused to the distal fiber end. The end block 34 minimizes the damage to the distal fiber end and somewhat decreases the beam's power density. The expanded pump beam then propagates over free space and is collimated in a collimator 36.

The collimated pump beam interacts with a frequency conversion scheme 40 (FIG. 2) including upstream and downstream nonlinear optical crystals (NLO) 38 such as lithium triborate (LBO). As pump light propagates through upstream NLO 38, the Raman-shifted fundamental frequency is doubled. The generated light at the doubled frequency and unconverted portion of pump light are first incident on a ½ wave-plate 41 which adjusts the polarization of the incident Red and IR light. The beams are further guided through downstream NLO 38 generating additional converted light at the doubled frequency by interacting with the remaining pump light. The dichroic mirror 42 spectrally separates converted and remaining IR pump beams which are further decoupled from head 16 through respective output ports 44, 46.

Based on the foregoing, the input collimator assembly or objective 32, as shown in FIG. 3, includes in addition to end block 34 a holder 45 and collimator 36. The configuration of collimator assembly 32 is bulky and thus contributes to a large footprint of laser head 16. The other major contributor to the overall large footprint of laser head 16 is the frequency conversion scheme including nonlinear crystals 38, respective crystal holder assemblies and guiding optics.

The miniaturization of laser head 16 started with replacing input fiber 14 with a fiber having a smaller core diameter which resulted in a reduced beam diameter of single mode (SM) pump light. The reduced beam diameter created a possibility of using miniaturized optical components. However, the reduced beam diameter increased the IR pump light power density or intensity (I) which is a ratio of power (P) in Watt (W) to the beam's cross section area (I=W/cm²). The higher the power density of light, the higher the optical efficiency of NLO 36. Thus the reduced beam diameter improves both compactness and frequency conversion efficiency. But the increased power density of SM IR pump light at the desired wavelength in a 1 μm wavelength range also creates problems at high IR maximum pump light powers reaching about 2 kW and higher.

At relatively low IR powers below, for example, 100 W, pump light presents no or very little environmental hazard when it is backreflected from end block 34. However, it all changes with a high power density provided that the SM pump operates in the above-disclosed IR power range. In fact, the high density light caused more than a fair share of unforeseen structural problems as explain below.

For instance, as high power IR pump light at a Raman-shifted wavelength is backreflected from end block 34, it is coupled into the cladding of fiber 14. Guided in the silica cladding, the backreflected light tends to decouple therefrom and damage a polymeric protective coating around the cladding which leaves the fiber vulnerable to the environmental hazard. A particularly dangerous impact on the exposed fiber can be caused by elevated temperatures since the laser source continues to work. Eventually, the fiber can be burnt and completely destroyed. A typical mechanism dealing with clad modes and known as the clad mode stripper or mode filter is made from silicon with a refractive coefficient higher than or similar to that of silica. However, when used alone, the mode filter's effectiveness was questionable at the desired high power density.

Furthermore, as the temperature increases during the laser operation, the refractive index of the cladding eventually equals that of the mode filter. As a result, the backreflected light, instead of decoupling from the cladding into the mode filter, keeps propagating in the cladding past the filter towards an input port of the housing through which fiber connector 30 extends into laser head 16. Typically, the interstices present in the input port around fiber connector 30 are sealed by epoxy making the interior of the housing near hermetic. When the high power backreflected light is incident on epoxy, it is compromised and may burn due to its low resistance to elevated temperatures. As a result, the encapsulated fiber can be easily damaged and the interior of the laser head is exposed to the surrounding environment which often leads to highly undesirable consequences. Moreover, high light power densities and associated therewith elevated temperatures in the experimental laser head caused the glue to outgas chemicals gradually dirtying and finally destroying the optical components. Clearly all of the above discussed problems associated with the existing collimator assembly which is located at the input of the known laser head and respective collimator assemblies at the output of the laser head needed to be rectified.

Still another problem with the IR input and output (dump) collimator assemblies is more relevant to Red lasers based on the Raman converter than to lasers generating other wavelengths in the visible spectrum. It is desirable to output red light in a broad wavelength range. For example, pump 12 of FIG. 1 can output light at a 1060±5 nm pump wavelength. The SM fiber Raman converter may induce, for example, the first, second, third and 4th order frequency Stokes shifts of the pump light covering a very broad wavelength range. Typically, a “good” anti-reflection (AR) coating reflects less than 3% of incident light, and even then its optical effectiveness is doubtful. Thus a need exists for an improved AR structure capable of effectively covering a few hundred nm spectral range.

FIGS. 4A-4C illustrate exemplary laser head 16 at one of the advanced developmental stages highlighting a series of problems associated with the frequency conversion assembly and more particularly with a crystal holder assembly 50. The crystal holder assembly 50 includes a thermo-electric cooler (TEC) 52 and resistant temperature detectors (RDT) such as thermistors (not shown) supported by optical bench 20, C-shaped bracket 54 and L-shaped jacket 56. The jacket 56 and bracket 54 are configured to hold crystal 38 in place by means of springs 60. The screws 58 (FIG. 4B) rigidly connect jacket 56 to bracket 54. The entire assembly is mounted on bottom 18 (FIG. 4A) of the laser head housing. Specific shapes and configurations of brackets 54 and jackets 56 can vary, but a combination of these elements with relatively thick bottom 18 and optical bench 20 renders assembly 50 to be too large, too high and heavy. The fully assembled laser head 16 of FIG. 4C has dimensions (W×L×H), mm corresponding to respective (105-115)×(215-220)×(60-75) mm. Although these dimensions may vary from one type of conversion schemes to another and in accordance with IR source parameters, the above disclosed footprint of laser head 16 is rather typical despite the fact that the laser head of FIG. 4C operates with the reduced beam diameter of IR light. Reiterating one of the problems this disclosure attempts to solve, the footprint and weight of the frequency conversion assembly need to be reduced.

The housing bottom 18, optical bench 20, and crystal jacket 54 all are made of copper (Cu). The material homogeneity, characterized by a uniform coefficient of thermal expansion (CTE), helps minimizing inevitable displacement of multiple components relative to one another during the operation. However, other laser head's elements, such as TEC 52, LBO crystals 38 (FIG. 2) and others, have respective CTEs different from that of Cu. The TEC 52 continuously adjusts the temperature of crystal 38. Cooling LBO crystal 38 during the generation of Red light or heating it during the Green light generation is necessary because a uniform (constant) temperature is a prerequisite for efficient frequency conversion. The LBO crystal has a peculiar reaction to elevated temperatures—it not only expands differently along two of its axes, but it also tends to contract along the third axis.

The expansion and contraction of LBO 38 causes its displacement relative to other components of crystal holder assembly 50 because its CTE is different from that of all Cu components and TEC 52. The displacement of the assembly components leads to increased thermal loads capable of deforming crystal 38 which decreases its conversion efficiency and often requires replacing the crystal 38.

To somewhat minimize the CTE mismatch between TEC 52 and crystal 18, crystal holder assembly 50 (FIG. 4A) uses C-shaped bracket 54 configured to prevent direct contact between TEC 52 and crystal 38, as shown in FIGS. 4A and 4B. The bracket 54 along with bottom 18 and optical bench 20 render assembly 50 high and, as a consequence, mechanically unstable when this assembly is in use. To minimize the undesirable instability, crystal holder assembly 50 utilizes screws 58 and springs 60 (FIG. 4B) which reliably secure C-shaped jacket 56 relative to crystal 38. A plate 62, which obviously is another element contributing to the height of the entire assembly, is placed between the crystal and fasteners so as to minimize the deformation of crystal 38 by bending moments generated by screws 58 on the crystal. Such a relatively rigid connection between crystal 38 and jacket 56 is undesirable because the crystal should “breath” during temperature fluctuations. Rigidly limiting its expansion may be a cause for the crystal's failure. Based on the foregoing, it becomes clear that the CTE mismatch should be minimized which can be done by carefully selecting materials for the assembly components that have substantially close respective CTEs. Based on the foregoing, the configuration of all assembly components should be altered so as to reduce the footprint of the laser head with a particular emphasis on the height of head 16.

Traditionally, the laser head packaging process includes assembling fiber-related, optical and electrical components separately from one another. Only after these groups of components are assembled, the packaging of laser head 16 starts. For example, electrical wires between TEC 52 and an external power source invade the interior of laser head and are manually connected to the TEC. Such a disintegrated method of assembling is too time consuming to be cost-effective in mass production.

Furthermore, as illustrated in FIGS. 4A-4C, Cu bottom 18 and optical bench 20 together define slightly less than half the height of laser head 16. It would be highly advantageous in light of mass production of laser heads 16 to use a thin base component substituting both bottom 18 and optical bench 20. Moreover, the thin base/bench component should be configured so as to eliminate manual packaging of laser head 16.

A need therefore exists for high power visible light lasers configured with a light, compact laser head in which:
an electro-optical printed circuit board (EO PCB) functionally and structurally replaces the housing bottom and optical bench of the known laser heads, and facilitates the automated assembly of the inventive laser head,
an input collimator assembly has a simple configuration preventing backreflected light from compromising the near hermetic state of the laser head's interior; and
a crystal holder assembly is configured with a light and compact structure configured to accommodate various components with different CTEs so as to minimize thermal stresses on LBO crystals.

### SUMMARY OF THE DISCLOSURE

These needs are satisfied by a modular visible fiber laser provided with an IR light source and laser head which is configured with a frequency converter. Several structural aspects related to respective laser head components and addressing respective problems enumerated above are disclosed. Each aspect includes one or more features which contribute to the miniaturized, light, automation-friendly and cost-effective laser head individually or in any combination with other features of the same and other aspects.

In accordance with one aspect, the inventive laser head is configured with an electro-optical printed circuit board (EO PCB) which is made of ceramic, covered by a metallized layer, and provided with electrical paths and precisely designated locations for respective optical and electrical components. The EO PCB thus functions as both the support base or bottom of the laser head and as an optical bench. It is used as an alternative to the massive Cu housing bottom and Cu optical bench which are stacked upon one another. The thin, light-weight EO PCB reduces the footprint and weight of the disclosed laser head and is important for automatization of the laser head's assembly process.

The EO PCB supports a frame which is made from Kovar or aluminum (Al) and extends generally along the edge of the EO PCB. One of the frame's sides is formed with an inwardly indented portion providing a pocket on the EO PCB. The pocket is shaped and dimensioned to receive an USB cable plug. The latter provides electric coupling between the electrical components of the laser head and outside devices such as a power source and controller. The indented portion of the frame isolates the USB plug from the rest of the head's interior and eliminates additional partitions and expansive materials which are typically installed in the known laser heads to isolate the plug from the interior of the laser head housing. The lid and frame may be manufactured as separate parts or as a one-piece part.

In accordance with another aspect, input and output IR collimator assemblies are mounted in the housing. The collimator assemblies each include a one-piece holder supporting a distal end of fiber which is coupled to an end block made of quartz, collimator and additional components, as discussed herein below.

According to one feature of this aspect, instead of glue coupling the distal fiber end and end block in the known collimator assemblies, these component are laser welded to each other. In contrast to the glue, the weld is highly resistant to substantial thermal loads which are produced by high power light within the housing.

Inevitably, when high power IR light propagates within the housing, it partially strays and is backreflected from the end block towards an input port. The input port receives a fiber connector which is sealed to the housing. The backreflected light jeopardizes the integrity of the seal which, when damaged, exposes the interior of the housing to the environmental hazard and sometime causes the fiber to burn.

Accordingly, another feature of this aspect helps minimizing propagation of stray backreflected light towards the seal. In particular, a light blocker is mounted on the holder between the end block and the input port. The location of the light blocker stops backreflected stray light from further propagation towards the seal.

One of possible configurations of the light blocker has a clamshell structure including bottom and top slabs. The bottom slab is mounted on the holder and has a top surface in contact with the bottom surface of the top slab. One of or both top and bottom surfaces are machined with respective generally U-shaped recesses which, when the top slab is mounted atop the bottom slab, form a channel traversed by a stretch of the fiber. The channel is dimensioned so that backreflected stray light is incident on distal faces of respective slabs which thus function as a protective barrier minimizing propagation of backreflected light.

In accordance with another configuration of the light blocker, two plates are both mounted on the holder so that their respective inner sides abut one another. Like to the slabs, one of or both abutted sides have respective small recesses which are aligned with one another thus forming a channel. The fiber extends through the channel which has an inner diameter slightly greater than the outer diameter of the fiber. The sides of respective plates, facing the end block, stop a major portion of backreflected stray light from further propagation towards the seal.

The backreflected IR light is also coupled into the cladding of the fiber and presents the same danger to the seal as stray light. To minimize the impact of the clad-guiding backreflected light, the fiber may be configured with a clad mode filter formed along a fiber stretch which is stripped from a polymeric protective layer and located between the light blocker and input port. The mode filter is made from silicon decoupling backreflected light from the clad due to different refractive indices with the refractive index of silicon being higher than that of silica. The light blocker and clad mode filter either individually or in combination with each other greatly minimize the amount of high power backreflected light incident on the seal.

Still another feature of this aspect includes a ferrule mounted on the holder and traversed by the fiber which is stripped from its protective layer. The central bore of the ferrule is barely larger than the outer diameter of the clad and substantially smaller than the channel formed in the light blocker. The ferrule can be paired with any of the light blocker and mode fitter or any of these elements individually or even used alone.

Still another feature of the inventive collimator assembly is more relevant to red lasers but, of course, may be used in all types of visible light lasers. To output red light in a broad wavelength range, as desired, IR input light preferably should cover a 1000−1400 nm wavelength range. Hence, in accordance with this inventive feature, the surface of the end block, which is laser welded to the fiber end, is provided with randomly arranged sub-wavelength-sized nanospikes. The structured surface of the end block proved to be effective in the desired absorption spectrum.

All of the above features become even more effective for the intended purposes if the fibers used in this invention are buffered with Teflon™ fluoropolymers. The latter provides the fibers with exceptional resistance to high temperatures, chemical reaction, corrosion, and stress cracking.

A further aspect relates to a frequency conversion assembly and, in particular, to a crystal holder subassembly. The main difficulties associated with the crystal holder subassembly stem from a peculiar reaction of LBOs to temperature gradients and multiple components with respective CTEs which differ from one another.

In accordance with one feature of this aspect, the crystal holder sub-assembly includes the TEC coupled to the EO PCB. The TEC is typically made of semiconductor n-type and p-type materials which have a CTE matching that of the EO PCB. The sub-assembly further includes a thermal jacket mounted atop the TEC and dimensioned to receive an LBO crystal, and an RDT.

The configuration of the thermal jacket takes into account different CTEs of respective LBO crystal and thermal jacket. Since the CTE mismatch between these components is practically inevitable, the disclosed thermal jacket has various modifications which each allow the LBO crystal to expand substantially unrestrictedly.

In accordance with one modification of the thermal jacket, two identical metal sheets are structured as respective halves of the thermal jacket. Each metal sheet is initially laser treated to have a series of spaced apart slits extending from one longitudinal edge of the sheet towards the opposite longitudinal edge. However, the slits terminate at a distance from the opposite edge. Thereafter the sheets each are shaped to have either a generally C-shaped cross-section or a Z-shaped cross-section. The shaped sheets are then mounted on the TEC or sub-mount or any other pedestal structure such that respective slotted edges face one another. The assembled sheets form an inner channel extending along a longitudinal axis and dimensioned to receive the crystal.

Based on the foregoing, the thermal jacket is configured with multiple clamps each having a pair of flexible arms which press against respective sides and top of the crystal. Such a contact between the jacket and crystal prevents displacement of the crystal relative to the jacket. However, the resilient arms do not substantially obstruct the LBO's expansion. As known, the greatest CTE of the LBO crystal is observed along its longitudinal axis, but the jacket has the opposite axially spaced ends open which allows the crystal to freely expand in the axial direction.

Another feature of the crystal holder relates to a jacket support structure which may include a ceramic sub-mount atop the EO PCB. A heating layer is mounted to the top of the sub-mount and covers the dielectric insulation. A dielectric layer is then placed atop the heating layer and the crystal jacket which is soldered to the dielectric layer by means of interposed solder pad. The dielectric layer between the heating layer and crystal jacket provides the electrical insulation between these components.

In accordance with a further feature aspect of the disclosure a majority of bulk optic components, such as lenses and mirrors, are supported by respective cradles which, in turn, are mounted directly on the EO PCB. One of the problems during the assembly of the laser head includes optically aligning the optical components after they are mounted to the head. The alignment is necessary to minimize losses of light within the laser head. The alignment may include tilting and rotating or yawing the cradle about an axis which is generally orthogonal to the plane of the EO PCB.

The cradle is configured with a base, supporting the optical component, and a pair of sides resiliently pressing against respective faces of the optical element. To provide tilting of the cradle, a pair of resilient leaves, which are cut and bent outwards from the cradle's bottom, are soldered to the EO PCB. Applying an external force directed to the EO PCB causes one of leaves yield. The yawing motion of the cradle is realized by a boss which, like the leaves, is formed on the outer surface of the cradle's bottom and coupled to the EO PCB.

The above and other aspects will become more readily apparent if considered in conjunction with the following drawings, in which:

### BRIEF DESCRIPTION OF THE DRAWINGS

FIG. 1 illustrates multiple known fiber laser assemblies including respective laser heads;

FIG. 2 is a top view of a laser head shown without a lid and configured in accordance with the known prior art;

FIG. 3 is an axial cross-sectional view of one of the known collimator assemblies;

FIG. 4A is an elevated perspective view of a crystal holder subassembly of the known prior art;

FIG. 4B is a sectional view of the crystal holder subassembly of FIG. 4A;

FIG. 4C is a perspective view of the known laser head including the crystal holder subassembly of FIGS. 4A and 4B;

FIG. 5 illustrates the inventive laser head;

FIG. 6 is a top view of the bottom of the inventive laser head of FIG. 5;

FIGS. 7A and 7B illustrate respective configurations of the input collimator assembly of the inventive laser head;

FIG. 8 is an elevated perspective view of another configuration of the disclosed input collimator assembly;

FIGS. 9A and 9B each illustrate still another configuration of the disclosed input collimator assembly;

FIG. 10 is a top view of the EO PCB of FIG. 6 with an exemplary electro-optical schematic of the inventive laser head of FIG. 5;

FIG. 11A is an exemplary sectional side view of the inventive laser head of FIG. 5;

FIG. 11B is another exemplary sectional side view of the inventive laser head of FIG. 5;

FIG. 12A is an elevated view of a crystal holder assembly;

FIGS. 12B and 12C are respective front views of the crystal holder of FIG. 12A featuring respective configurations of a crystal clamp or thermal jacket;

FIG. 12D illustrates one half of the thermal jacket of FIGS. 12B and 120;

FIGS. 12E and 12F are respective assembled and exploded views of the modification of the thermal jacket of FIGS. 12B-12D;

FIGS. 13A-13C are respective exploded, top and bottom views of a pedestal supporting the crystal holder sub-assembly of FIG. 12A;

FIGS. 14A and B are respective schematic views illustrating different techniques for mounting optical components to the EO PCB of FIG. 6; and

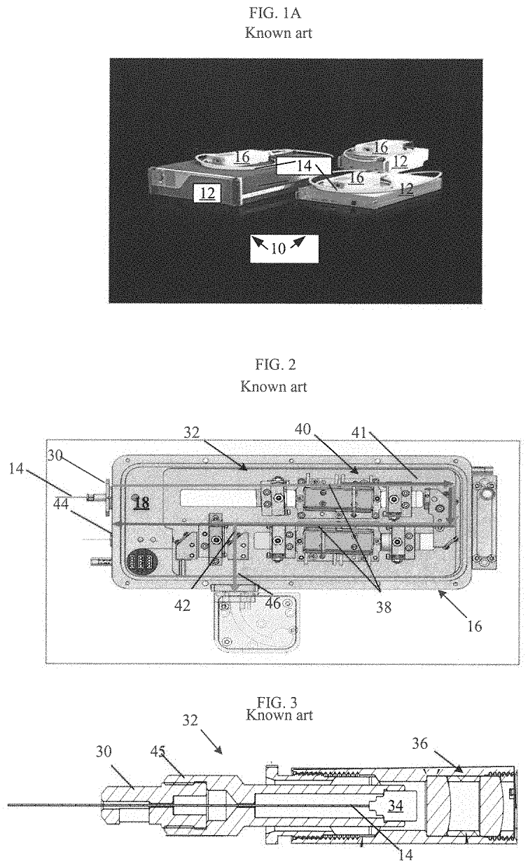

15A-15C are respective elevated views of a bulk component holder.

### SPECIFIC DESCRIPTION

Reference will now be made in detail to the disclosed subject matter. Wherever possible, same or similar reference numerals are used in the drawings and the description to refer to the same or like parts or steps. The drawings are in simplified form and are far from precise scale. For purposes of convenience and clarity only, the terms “connect,” “couple,” “combine” and similar terms with their inflectional morphemes do not necessarily denote direct and immediate connections, but also include connections through mediate elements or devices.

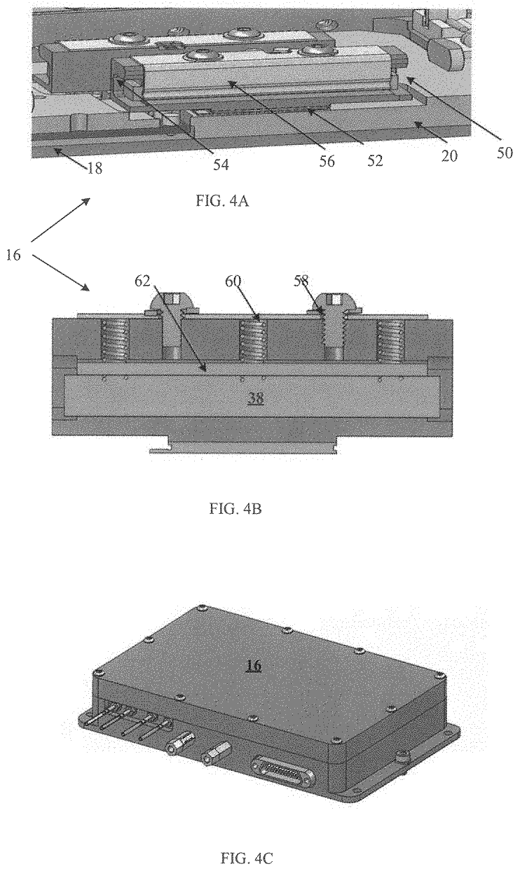

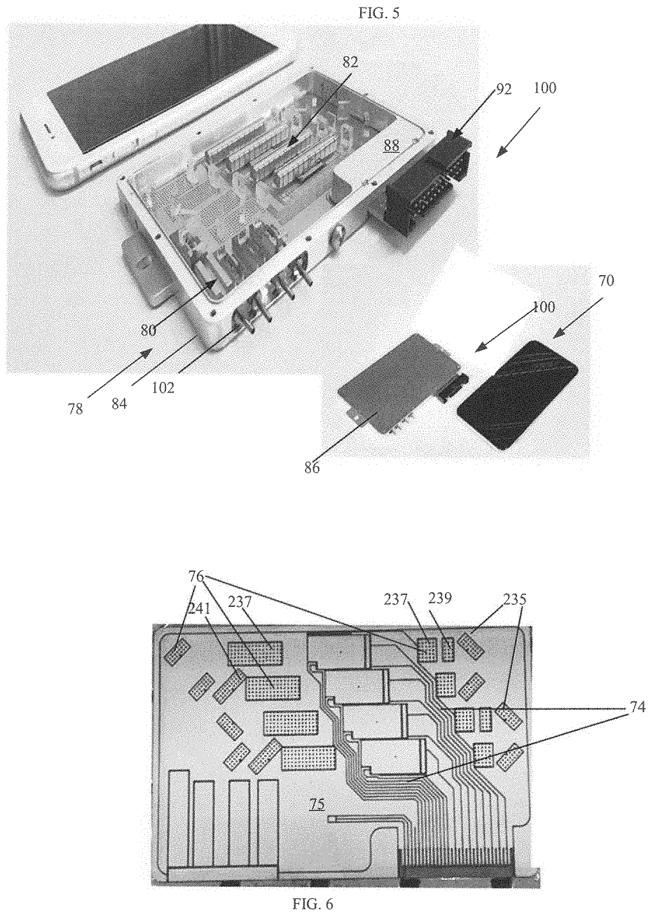

FIG. 5 illustrates inventive miniature laser head 100 having a footprint which is comparable to that of a typical I-phone 70. Although the dimensions of laser head 100 may somewhat vary, the known smallest laser head laser head 16, which is shown in FIGS. 4A-4C, is 75 mm wide (W), 120 mm long (L) and 22 mm high/thick (H). By comparison, disclosed laser head 100, undergoing laboratory tests, is 75 mm (W)×112 mm (L)×8 mm (H). Depending on the inventive structure, the height/thickness of the laser head's housing may vary between 5 and 10 mm. The compactness of inventive laser head 100 is a result of reconfiguration of a few major head components including, among others, a housing 78, input collimator assembly 80, output collimator assemblies and crystal holder assemblies 82.

Referring to FIG. 6 in combination with FIG. 5, housing 78 is configured with a bottom 75 (FIG. 6), frame 84 and lid 86 (FIG. 5). Based on the dimensions of laser head 100, disclosed in the previous paragraph, it is its height/thickness that has been drastically reduced by comparison to the known laser head of FIGS. 4A-4C. There were two major elements that needed to be redesigned so as to provide laser head 100 with a miniature structure: bottom 75 of housing 78 and crystal holder assemblies 82 (FIG. 5).

By contrast to the known laser head featuring a combination of massive Cu bottom and optical bench, bottom 75 is made of a ceramic, such as aluminum nitride (AlN) or beryllium oxide (BeO), and also functions as the optical bench. With precisely defined locations 76 for respective optical components and electrical traces 74 for electrical components, conceptually and functionally the bottom 75 is an electro-optical printed circuit board (EO PCB). The latter is one of salient features of this disclosure considering maximum powers of pump and converted light which will be specified hereinbelow. The optical components may include folding mirrors 235, dichroic mirrors 241, and focusing lenses 237. The improved configuration of bottom 75 is critically important for a fully automated assembly of laser head 100.

The frame 84 (FIG. 5) may be made of Kovar or, preferably, aluminum (Al) or any other light durable material with the desired thermal and electrical properties substantially matching those of bottom/EO PCB 75. It can be glued, blazed, soldered or laser welded to the EO PCB and covered by a lid 86 which is preferably made from the same material as frame 84. The frame 84 and lid 86 can be two separate parts, which are coupled to one another during the head assembly, or a one-piece monolithic part.

One of the sides of frame 84 has a portion thereof indented inwards to provide a pocket 88 (FIG. 5). The latter is shaped and dimensioned to receive an USB cable plug which is generally denoted 92. The plug 92 provides electric coupling between the TECs and RDTs and outside devices such as a power source and controller via respective electrical traces 74 (FIG. 6). The indented portion of the frame isolates USB plug 92 from the rest of the head's interior.

The miniaturization of the disclosed laser head is predicated on the beam diameter. For example, currently, the delivery fiber has a 14 μm core outputting a beam with a 14 μm beam diameter which is four times less than that of the known laser head designs. The core diameter is generally inversely proportional to light intensity, which means that, in disclosed laser head 100, the light intensity is four times higher than that in the known designs. Considering that single mode pump IR light may have a maximum power in a 1-2 kW range at selected wavelengths in 1 μm spectral range, the light intensity at the distal end of the delivery fiber raises safety concerns. Furthermore, such high intensity light is damaging to adhesives which degas at elevated temperatures affecting connections among elements, optical components and, of course, fiber ends. To lower the risk associated with high intensity light the distal end of the delivery fiber is laser welded to a so-called end block made from quartz. However, the end block in combination with high intensity forward propagating pump light proved to be highly problematic because it also reflects the incident light. The backreflected light propagates toward input port 102 (FIG. 5) and destroys the material, such as epoxy, sealing this port. Accordingly, disclosed input collimator assembly 80 not only has a compact configuration, but it is also configured with multiple components minimizing propagation of the backreflected light as discussed immediately below.

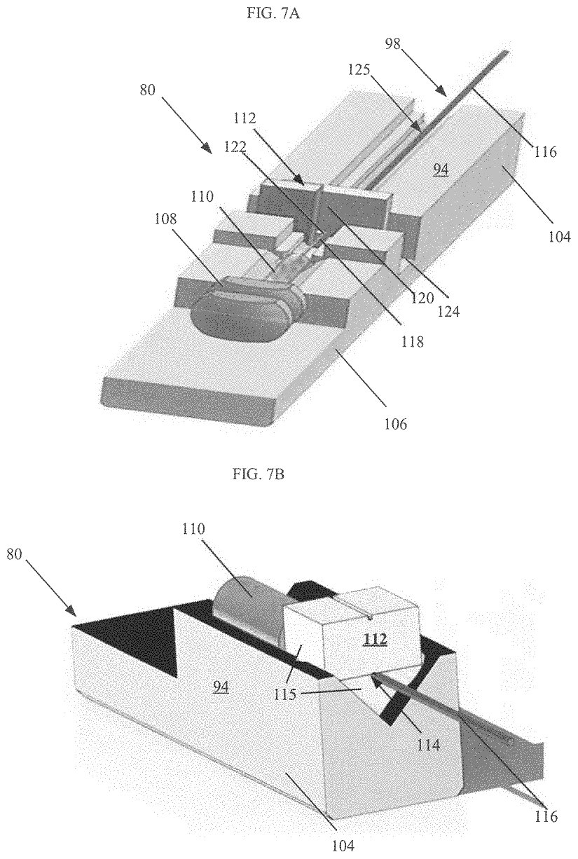

FIGS. 7A, 7B, 8, 9A and 9B illustrate input collimator assembly 80 which is configured with a holder 94 glued or, preferably, soldered to EO PCB 75 (FIG. 6). The holder 94 is made from ceramic material characterized by a CTE which substantially matches that one of the EO PCB. Functionally, holder 94 of FIG. 7A supports optical elements including, among others, collimator lenses 108, end block 110 made of quartz, light shielding block 112 and delivery fiber 98. Structurally, holder 94 extends between a proximal end 104 and a distal end 106 which is thinner than proximal end 104. The holder 94 may be monolithic or have separate pieces coupled together.

The collimator assembly 80 is one of the major contributors to the overall miniaturized configuration of the disclosed head. The prior art collimator assembly is typically 12-15 mm long. In contrast, the disclosed collimator assembly is at most 10 mm long which is a result of miniaturized assembly elements. For example, cylinder-shaped end block 110 has a 1-2 mm diameter and is 3-5 mm long. In contrast, the diameter of the end block used in the known laser head of FIG. 3 is 4-8 mm, whereas the end block's length is minimally 6 mm.

The end block 110 is part of the problem associated with high light intensity. Mostly, the IR pump light is guided in the fiber core. When fiber 98 delivers the pump IR light to end block 110, a portion of this light is partly coupled back into fiber 98 and particularly into its cladding 118 (FIG. 7A) which guides the coupled light backwards to sealed input port 102 (FIG. 5). This backreflected light presents a double jeopardy. Firstly, it may decouple from cladding 118 as it propagates therealong. If the decoupled light is incident on sealed input port 102 (FIG. 5), the seal, which is typically made from epoxy, is easily destroyed due to elevated temperatures. Once the seal is damaged, the near hermetic interior of the laser head is compromised which may irreparably affect the entire operation of the laser head and fiber 98 may simply burn. Secondly, even before reaching port 102, the backreflected light guided along cladding 118 reaches a portion of fiber 98 covered by protective polymeric layer 116 (FIG. 7A). Like epoxy, layer 116 is vulnerable to elevated temperatures associated with high power intensity of the backreflected light and, once damaged, exposes fiber 98 to elevated temperatures. To deal with high intensity backreflected light, input collimator assembly 80 is provided with a light-blocking assembly, as disclosed in detail immediately below.

Referring to FIG. 7A, proximal end 104 of holder 94 has a channel 114 receiving double-clad single mode (SM) fiber 98 which includes a small-diameter core, cladding 118 and protective polymeric layer 116. Preferably fiber 98 is buffered with Teflon™ fluoropolymers. A major portion of fiber 98 extending within input collimator assembly 80 is stripped from protective layer 116. The distal fiber end is laser welded to end block 110.

One of the elements of the light blocking assembly is a blocker 112 which is mounted on holder 94 between end block 110 and holder's proximal end 104. The blocker 112 is configured with two plates 120 sliding inwards towards each other perpendicular to the longitudinal axis of holder 94 in a passage 124. The latter is formed in holder 94 between holder's distal and proximal ends 106, 104 respectively. One or both plates 120 have a small slit 122 which is traversed by fiber 98 and formed in the inner side of plate(s) 120 such that it is aligned with collimators 108, channel 125, which is provided in the top surface of holder's proximal end 104 for supporting fiber 98, and sealed input port 102 (FIG. 5). The alignment allows fiber 98 to avoid undesirable bends within the interior of laser head 100. The light blocking faces of plates 120 effectively prevent a major portion of decoupled backreflected light from reaching port 102.

FIG. 7B illustrates an alternative configuration of light blocker 112 including bottom and top blocks 115. The bottom block 115 has channel 114 receiving fiber 98 which has its protective layer 116, removed along its length between the entrance into light blocker 112 and end block 110. The top block 115 is mounted on the grooved top surface of bottom block 115 and covers channel 114 which thus defines a passage traversed by the distal end of fiber 98 stripped from protective layer 116. Alternatively, channel 114 may be provided in the top block. Similar to the configuration of FIG. 7A, channel 114 is aligned with input port 102 of FIG. 5, end block 110 and collimator lenses 108 (FIG. 7A). Unfortunately, due to the known limitations of cutting tools, slit 122 of FIG. 7A and channel 114 of FIG. 78 are still too large allowing a substantial amount of backreflected light to reach for input port 102. Hence light blocker 112 alone may not always be adequate for the intended light-blocking purposes.

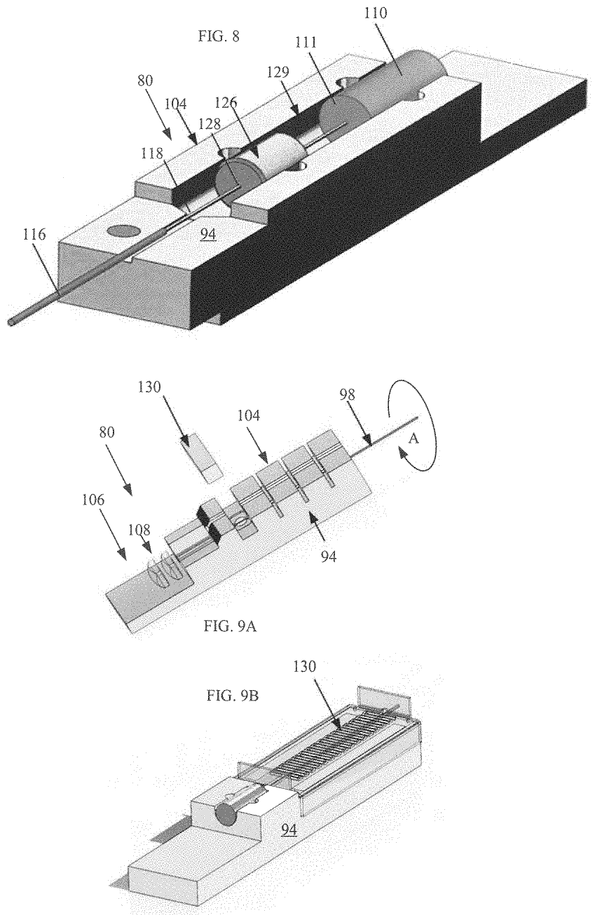

FIG. 8 illustrates an alternative or additional light blocking element—a ferrule 126 which is mounted on proximal end 104 of holder 94 between sealed input port 102 (FIG. 5) and end block 110. The ferrule 126 is made from ceramics and drilled to have a central passage 128 which is only slightly greater than the outer dimeter of cladding 118 which here is unprotected by layer 116. For example, with a 125 μm cladding diameter, central passage 128 is 126 μm in diameter and 3 mm long. Although ferrule 126 may be used alone, its combination with light blocker 112 of FIGS. 7A and 7B was found to be highly effective practically blocking the entire decoupled backreflected light from being incident on sealed input port 102. If ferrule 126 and end block 110 are used together, holder 94 may be configured with an elongated U-shaped central groove 129 which receives both light blocking elements such that they are coaxial with one another and further with collimator 108 of FIG. 7A and input port 102 of FIG. 5.

FIGS. 9A and 9B illustrate an alternative concept of input collimator assembly 80. The holder 94 may have a multi-level configuration with distal end 106 supporting FAC and SAC 108. A distinctive feature of holder 94 shown in these figures includes a plurality of separate U-shaped spring clamps 130 that can be attached to proximal end 104 of holder 94 and hold the fiber in place before input collimator assembly 80 is glued to EO PCB 75 (FIG. 5). Cut from sheet-metal, such as copper, aluminum and others, miniature spring clamps 130 are flexible, and therefore can withstand high thermal loads even if the CTEs of respective sheet metal and part, which is in contact with spring clamps 130, mismatch one another. In contrast to the configuration shown in FIGS. 7 and 8, holder 94 is mounted on EO PCB 75 with springs 130 being glued to the board. In other words, holder 94 is turned over to an installed position, as indicated by arrow A, before coming into contact with the EO PCB 75 of FIG. 6. In the installed position, fiber 98 extends between aligned input port 102 (FIG. 5) and end block 110. Once installed, spring clamps 130 limit the displacement of fiber 98 off the channel's bottom which helps the fiber to extend without undesirable bends. In the installed position, spring clamps 130 are spaced apart which reduces the contact surface between them and EO PCB 75 which, in turn, further improves the resistance of these clamps to high thermal loads.

Returning to FIG. 8, to minimize the amount of backreflected light, a face 111 of end block 110, which is welded to the distal fiber end, is covered by an anti-reflection (AR) coating. Typically, the AR coating effectively suppresses light having a relatively narrow spectral width. If the disclosed laser head, however, is used for outputting Red light, it is desirable that the latter have a broad spectral width. This is realized by providing a laser pump source having a Raman converter (not shown here) which induces the first, second, third and 4th order frequency Stokes shifts of the pump light at 1112±5 nm, 1170±5 nm, 1226±2 nm and 1290±2 nm respectively. The “tails” of this spectrum extending way beyond the 1^{st} and 4^{th} Stokes shifts. Such a broad spectral range requires an anti-reflection (AR) coating on end block 110 covering an even broader 1000-1400 nm wavelength range which would be unrealistic even if the best known AR coatings were used here. Instead, the anti-reflective face 111 of end block 110 is reliant on the engineering of the surface textures and patterns to enable efficient trapping or transmission of light. Using any of known techniques, the nanostructured surface of end block 110 has no trouble to effectively suppress backreflected IR light over the desired 400 nm spectral range.

Turning back to FIG. 5, the other laser head element majorly contributing to the head's small footprint is inventive crystal holder assembly 82 of the disclosed frequency conversion scheme. The configuration of crystal holder assembly 82 is discussed hereinbelow.

FIG. 10 shows practically a fully assembled optoelectronic scheme mounted on EO PCB 75 of the inventive laser head which is configured to output Red light. Following the path of collimated IR light within the interior of the laser head, it sequentially propagates through upstream, two intermediate and downstream frequency conversion stages all based on respective SHGs. The SHGs are realized by respective LBOs which are supported by respective crystal holders 82₁, 82₂, 82₃ and 82₄. At the output of first intermediate SHG 82₂, Red light, generated in upstream and first intermediate LBOs, is guided outside laser head 100 through a first Red light output collimator assembly 234, whereas Red light, converted in the second intermediate and downstream LBOs, leaves laser head 100 through a second Red output collimator assembly 236. The unconverted IR light is guided through a dump assembly 238. The output Red and unconverted IR pump light may be coupled into respective output fibers or propagate over free space. The output collimator assemblies 234, 236 each have a configuration similar to that of input collimator 80.

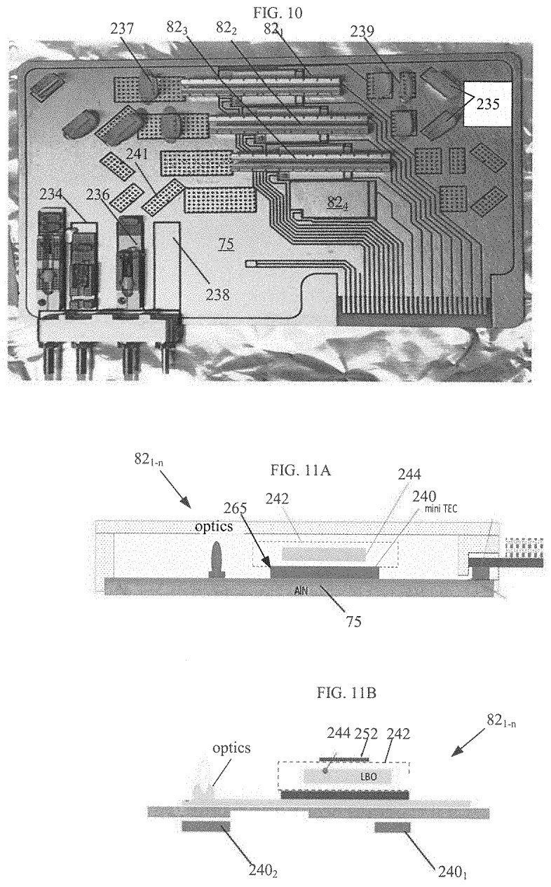

Referring to FIGS. 11A and 11B, a general structure common to all crystal holder assemblies 82₁₋₄ of FIG. 10 includes a base 265 mounted on EO PCB 75 and configured with, among others, a thermoelectric cooler (TEC) 240. Based on ceramics, such as Bismuth Telluride (Bi₂Te₃), TEC 240 and EO PCB 75 have respective TCEs which are not drastically mismatched. Instead of single TEC 240, two separate TECs 240E and 2402 (FIG. 11B) may be used to provide and control the desired thermal regime. The TEC 240 supports a thermal jacket 242 which encloses LBO 244. A resistant temperature detector (RTD) 252—another element of the crystal holder assembly 82—may be mounted on base 265, or, as shown in FIG. 11B, on top of thermal jacket 242. The latter configuration may be advantageous for the frequency conversion scheme generating Green light. The latter requires only two conversion stages or cascades to convert IR light at the fundamental frequency to Green light having a maximum power of about 1000 kW at the selected wavelengths which depend on the wavelength of IR pump light.

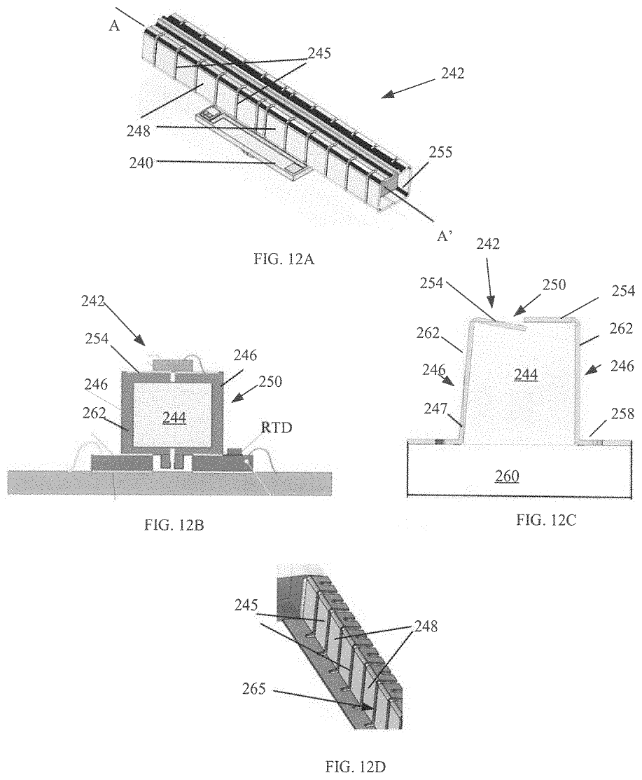

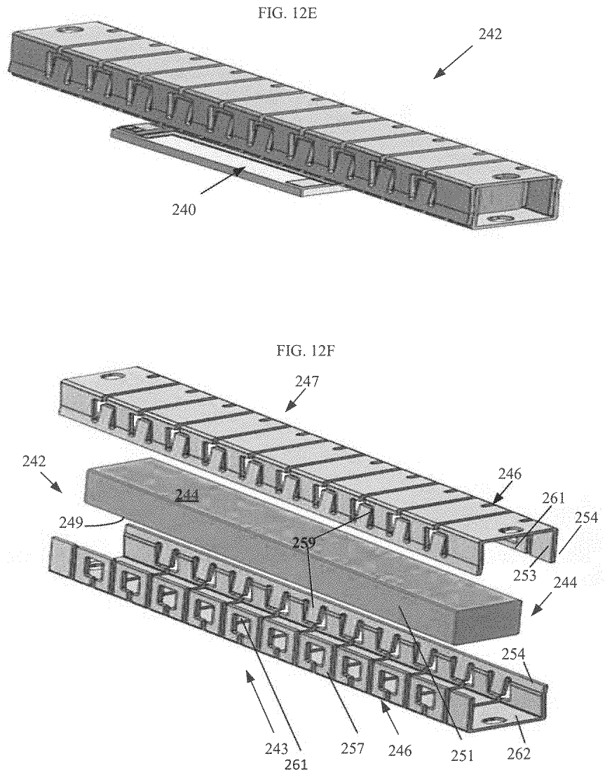

Referring to FIGS. 12A-12C, the configuration of thermal jacket 242 takes into account a unique reaction of LBO 244 to elevated temperatures along different crystal axes. Conceptually, jacket 242 allows LBO 244 to expand/contract in response to a thermal gradient without imposing excessive loads on the crystal which, otherwise, may lead to the crystal's mechanical and optical failures. This concept is realized by a laser processing a sheet metal piece to form a plurality of brackets 246 (FIGS. 12B and 12C), as discussed below.

The jacket 242 includes two rows (or halves) of individual C-shaped brackets 246 which are grouped so that each pair of brackets 246, which are aligned in a plane perpendicular to the longitudinal axis A-A′ of LBO 244 (FIG. 12A), define a clamp 250 (FIGS. 12B, 12C). The fabrication of brackets 246 includes, for example, laser-cutting the sheet metal piece into a plurality of spaced apart individual/detached segments 248 (FIGS. 12A and 12D) which are then shaped into respective C-contoured brackets 246.

As shown in FIG. 12C, before LBO 244 is inserted into jacket 242, vertical sides or bases 262 of respective brackets 246, which define clamp 250, converge. As a result, top flanges 254 of clamp 250 overlap each other. Accordingly, as shown in FIG. 12B, upon insertion, LBO 244 presses upon and spreads out top and bottom flanges 258 of respective brackets 246 of each clamp 250. When fully inserted, the inner periphery of each clamp 250 conforms the outer periphery of enclosed part of LBO 244. Thus, on one hand, flexible brackets 246 of each clamp 250 are in continuous contact with crystal 244 regardless of whether the latter expands or contracts. On the other hand, nothing limits the expansion of crystal 244 along its longitudinal axis A-A′ since opposite ends 255 (FIG. 12A) of jacket 242 are open.

Revisiting FIG. 12C it is easy to see that each bracket 246 has a Z-shaped cross-section. The jacket 242 of FIG. 12C is mounted on an optional pedestal 260 which is made of material that may mitigate the mismatch between CTEs of jacket 248 typically made from Cu and TEC 240 (FIG. 11A) respectively.

In alternative structural aspect, the sheet metal may be processed to have multiple recesses 245 (FIG. 12A) terminating at a distance from one of the sheet's opposite longitudinal edges. In this configuration, upon applying a C- or Z-shape to the processed sheet, each row has a continuous base 265 (FIG. 12D) which supports a plurality of individual, spaced apart segments 248 (FIG. 12A).

FIGS. 12E-12F illustrate a modification of thermal jacket 242. In FIGS. 12A-12D. In particular each bracket 246 (FIGS. 12C and 12D) has its base 262 engaging the side of crystal 244 which extends perpendicular to bottom 75 of the housing (FIG. 6), whereas flanges 254 are juxtaposed with respective top and bottom of crystal 244 (FIG. 123) or just the top (FIG. 12C). The jacket configuration of FIGS. 12A-12D for purposes of convenience is referred to as a horizontal structure. Once assembled, this horizontal structure is placed on TEC 240 of FIG. 12A and heated which exposes crystal to unnecessarily high thermal loads leading to reliability concerns during and after the reflow.

The jacket 242 of FIGS. 12 E and 12F is configured to solve this issue. In contrast to the horizontal structure, jacket 242 of FIGS. 12E-12C has a vertical structure in which a bottom half 243 of jacket 242 which receives crystal 244 with its top covered by an upper half 247. Such a configuration first allows bottom half 243 (FIG. 12F) alone to be reflowed on TEC/heater 240 (FIG. 12E) without crystal 244 and upper half 243. Then crystal 244 and top half 247 are installed later at a room temperature. In the assembled horizontal structure of jacket 242 a bottom 249 (FIG. 12F) of the crystal rests on bases 262 of respective brackets 246 while crystal's sides 251 press upon the inner surfaces 253 of respective flanges 254 of the brackets of one of the halves, for example, bottom half 243 as discussed below.

The halves 243 and 247 of jacket 242 are configured with a micro latching array. The latching assembly which allows brackets' flanges 254 of, for example, the top half 247 overlap outer surfaces 257 of respective flanges 254 of bottom half 243. The configuration of the latching assembly includes a resilient tounges 259 cut out of respective flanges 254 of brackets 246. However, only one side of the brackets of each of the halves has tounges 259, and these are located diagonally relative to one another when jacket 242 is fully assembled. The other sides of respective halves 243, 247 have respective openings 261 formed in flanges 254. During the final assembly, upon placing LBO 244 within bottom half 243, top half 247 slides down such that tounges 259 of one of the halves protrude through respective openings 261 of the other half and resiliently press inwardly against respective opposite sides 251 of crystal 244. As better seen in FIG. 12E, flanges 254 of one half straddle one of flanges of the other half. A slight modification of this structure include forming tounges 259 in both flange of one of the halves 243, 247 while providing openings 261 in flanges 254 of the other half. However thus modified structure is less resistant to external and internal loads than the one shown in FIGS. 12E and 12F.

Depending on whether the inventive laser head is configured to Green or Red light, not only the number of necessary optical frequency conversion stages—two for Green and 4 for Red—varies, but also the position of TEC 240 (FIG. 12A) can vary. The generation of Green light requires that TEC 240 operate in a heating regime, whereas Red light is obtained with TEC 240 operating in a cooling regime. If the inventive laser head is configured to lase Green light, then TEC 240 should be safely spaced from both crystal 244 and EO PCB 75 (FIG. 10). In this case, TEC 240 is advantageously mounted atop thermal jacket 242. In contrast, TEC 240 is part of base 265 of FIG. 11A supporting jacket 242 when the disclosed laser head outputs Red light. D depending on a maximum power of IR pump light at the fundamental frequency, Red light can reach a maximum power of about 750 kW at the desired wavelength. Different positions of TEC 240 based on Green and Red light generation present a structural problem.

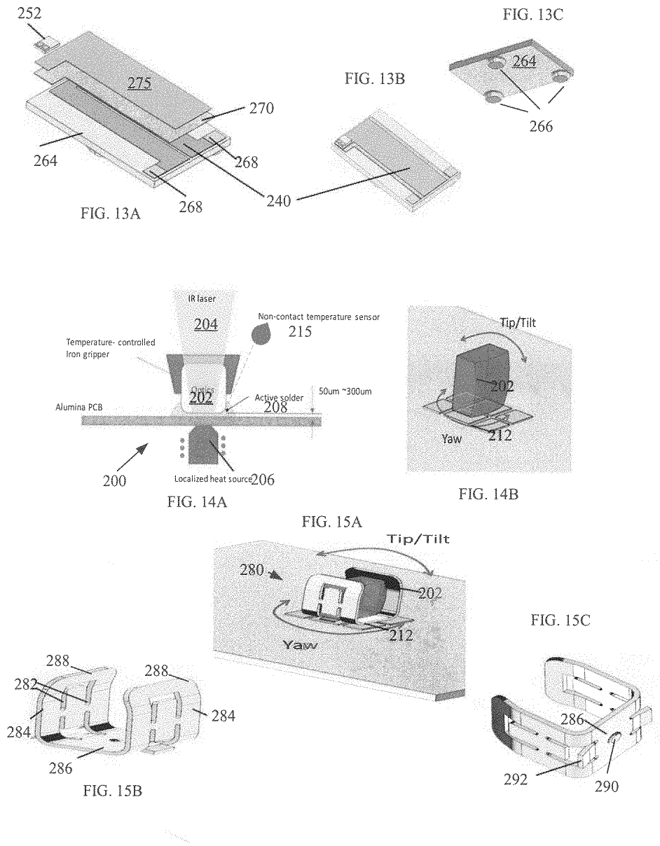

FIGS. 13A-13C illustrate a structure which is successfully used in both heating and cooling regimes of TEC 240 and can be better understood in combination with FIG. 12A. When the inventive laser head is part of a laser system generating Green light, it is highly desirable to limit heat generated by TEC 240, from affecting adjacent elements. To realize the desired thermal protection, a ceramic pedestal 264 of base 265 is provided with a plurality of low dielectric conductive ceramic studs 266 (FIG. 13C) attached to the bottom of EO PCB 75.

The TEC 240 is mounted atop pedestal 264 provided with two heater pads 268 which are wire bonded to the EO PCB. The TEC 240 is soldered to the metalized top of pedestal 264 between pads 268. To provide electric insulation between the TEC and jacket 242, a dielectric insulation layer 270 is sandwiched between the TEC and jacket soldered pad 275. The thermistor 252 is mounted on solder pad 275 and electrically coupled to EO PCB 75. Having taken care of heat in a Green light regime, nothing prevents the disclosed base from being effective when the shown structure is used for generating Red light which may have a maximum high power of about 750 W.

FIG. 14A illustrates an exemplary assembly 200 for soldering optical element 202, such as folding mirrors 235, focusing lenses 237, half-wave polarization plates 239 and dichroic mirrors 241 (FIG. 10) directly to EO PCB 75. The assembly 200 includes an IR laser source 204 and a localized heat source 206 which are aligned with optical element 202 to be soldered while facing respective top and bottom of EO PCB 75. The optical element 202 can be held in place by a temperature-controlled gripper 210 as laser and heat sources 204, 206 respectively affect an active solder 208 between element 202 and EO PCB 75. The non-contact temperature sensor 215 is coupled to solder 208 and outputs a signal which is received in a processor which evaluates the received signal. If the received signal is outside the desired range, either one of or both heat sources 204, 206 are appropriately adjusted.

Referring to FIG. 143, optical element 202 is coupled to EO PCB 75 using ultrasonic solder activation. In the shown arrangement, a solder preform 212 or non-collapsible elastomer solder balls (not shown) are pre-bonded to EO PCB 75, and then element 202 is bonded to the pre-form or solder balls. The element 202 may be optionally metallized. However, even without metallization, element 202 can be reliably coupled to the pre-form/solder balls. The bonding process may include ultrasonic solder activation. The alignment of element 202 including yawing and/tipping/tilting can be done before and/or during its soldering.

FIGS. 15A-15C illustrate an alternative configuration for coupling optical element 202 to EO PCB 75. Instead of directly coupling optical element 202 to the board, the illustrated configuration includes a ctounge 280 (FIG. 15A) receiving optical element 202. The ctounge 280 is made from sheet metal material, such as copper and has a C-shaped cross-section defined by a pair of spaced apart flanges 284 (FIG. 15B) and a bottom 286. The recessed flanges 284 press against received optical element 202 (FIG. 15A) so as to prevent its lateral displacement. The top segments 288 (FIG. 15B) of respective flanges 284 are bent inwards to ensure a reliable contact between element 202 and bottom 286.

During formation of recesses 282 (FIG. 15B) in each flange 284, a small part of sheet-metal material is not removed, but bent out in the vicinity of bottom 286 forming two flexible arms 292 (FIG. 15C). The bottom 286 of ctounge 280 is embossed at 290. The formations are soldered to preform 212 (FIG. 15A) and facilitate optical alignment of ctounge 280 providing the ctounge with yawing and tilting motion.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. The disclosed laser head is going through a battery of experiments necessitating the modification of the disclosed embodiment in general. Some of possible variations of the laser head components are illustrated by the attached additional drawings which are self-explanatory and intended to be part of this disclosure. Accordingly, examples of specific implementations are provided herein for illustrative purposes only and are not intended to be limiting.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “configured,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls.

Having thus described several aspects of at least one example, it is to be appreciated that various alterations, modifications, and improvements will readily occur to those skilled in the art. For instance, examples disclosed herein may also be used in other contexts. Such alterations, modifications, and improvements. Accordingly, the foregoing description and drawings are by way of example only.

1. A laser head for a high power fiber laser system, comprising:
a 5 to 10 mm high housing having a bottom;
an input collimator assembly mounted to the housing and operative to collimate a single mode pump light at a fundamental frequency and maximum power of 2 kW;
a multi-cascaded nonlinear frequency converter located in the housing and receiving the collimated pump light so as to convert the fundamental frequency into a higher harmonic thereof, wherein converted light at the higher frequency has a maximum power of 1 kW;
a plurality of electronic and light guiding optical components mounted in the housing, wherein the bottom of the housing is an electro-optical printed circuit board (EO PCB) which directly supports the input collimator assembly, multi-cascaded nonlinear frequency converter, electronic and optical components at respective designated locations.

2. The laser head of claim 1, wherein the multi-cascaded nonlinear frequency converter includes two or more sequentially located second harmonic generator assemblies each operative to generate a second harmonic of the fundamental frequency.

3. The laser head of claim 1, wherein the pump light is coupled into the input collimator assembly at a desired fundamental wavelength in a 1 μm spectral range, the converted light at the second harmonic being Green light at a desired wavelength having the maximum of 1 kW power or Red light at a desired wavelength having the maximum power of 750 kW.

4. The laser head of claim 1, wherein the input collimator assembly is configured with:
a holder extending along a longitudinal axis,
a collimator mounted on a distal end the holder and being coaxial therewith,
a quartz end block mounted on the holder between the collimator and proximal end of the holder and extending along a block axis, and
a ferrule mounted on the holder between the quartz end block and proximal end of the holder, the ferrule having a passage coaxial with the quartz end block and collimator and traversed by a single mode (SM) delivery fiber which has a distal end thereof directly coupled to a proximal end of the quartz end block,
wherein the delivery fiber guides the pump light at the fundamental frequency which is incident on the quartz end block and partially backreflected therefrom, the ferrule being dimensioned to minimize propagation of the backreflected light towards the proximal end of the support.

5. The laser head of claim 4, wherein the input collimator assembly includes a light blocker mounted on the holder between the ferrule and end block, the light blocker having a distal side which faces the quartz end block and being configured to reflect the backreflected light.

6. The laser head of claim 5, wherein the light blocker includes two plates mounted to the holder and displaceable perpendicular to a longitudinal axis of the holder towards one another to an installed position, the plates being configured to define a recess between respective sides opposing one another in the installed position, the recess being traversed by the delivery fiber and coaxial with the collimator, end block and the passage of the ferrule.

7. The laser head of claim 5, wherein the light blocker is configured with two blocks mounted upon one so that respective sides, opposing one another in an installed position, define a longitudinal passage coaxial with the collimator, end block and ferrule and traversed by the delivery fiber.

8. The laser head of claim 5 further comprising a fiber connector mounted to an input port of the housing coaxially with the passages of respective ferrule and light blocker, wherein the delivery fiber extends has a strait length between the fiber connector and end quartz block, the input port having a seal which is shielded from the backreflected light by the light blocker and ferrule and maintains a near hermetic interior of the housing.

9. The laser head of claim 4, wherein the proximal end of the quartz end block has a surface provided with a plurality of randomly arranged antireflection nanospikes which each are dimensioned to be smaller than a fundamental wavelength of the pump light.

10. The laser head of claim 4, wherein the quartz end block has a cylinder-shaped cross-section and is dimensioned with a 1-2 mm diameter and is 3-5 mm length.

11. The laser head of claim 2, wherein the nonlinear frequency conversion assemblies each are configured with a crystal holder mounted on the EO PCB, each crystal holder including a jacket, the jacket being configured with two longitudinal halves of flexible brackets made from a sheet-metal material and arranged to define an open-ended inner channel which receives a nonlinear crystal, the nonlinear crystal being lithium triborate (LBO),
wherein the flexible brackets each press resiliently against an adjacent surface of the LBO so that the flexible brackets and LBO are in contact with one another regardless of expansion or contraction of the LBO.

12. The laser head of claim 11, wherein the flexible brackets of each row are completely separated from one another or have a common support.

13. The laser head of claim 11, wherein the LBO has opposite sides, top and bottom which faces the EO PCB, the flexible brackets of respective halves each having a base and opposite flanges, wherein
the base and opposite flanges of each bracket together define a C-shaped cross-section and resiliently press against respective side, top and bottom of the LBO, or
the base and opposite flanges of each bracket together define a Z-shaped cross-section and resiliently press against respective side and top of the LBO.

14. The laser head of claim 11, wherein the LBO has opposite sides, top and bottom which faces the EO PCB, flexible brackets each have a base and opposite flanges together defining a C-shape,
the base of each C-shaped bracket of one half engaging the top of the LBO while the flanges facing respective sides of the LBO, and the base of each bracket of the other half engaging the bottom of the LBO while the flanges thereof facing respective sides of the LBO.

15. The laser head of claim 14, wherein one of the flanges of respective brackets of each half of the jacket have respective tongues, and the other flanges of respective brackets of each half have respective openings, the flanges of respective halves being overlapped with one another in an assembled position of the jacket in which the tongues protrude through corresponding openings toward opposing sides of the LBO and resiliently press against them.

16. The laser head of claim 11, wherein the crystal holder further includes:
a base provided with a plurality of studs which extend from a bottom of the base to rest on the EO PCB,
a thermoelectric cooler (TEC) mounted on the base,
a dielectric insulation layer sandwiched between the TEC and the crystal jacket, wherein the base and the TEC being made of a material with a coefficient of thermal expansion matching that of the EO PCB.

17. The laser head of claim 1 further comprising a plurality of clips each made of sheet metal material and having a C-shaped cross-section which is defined by a pair of recessed flanges bridged by a bottom, the clips being dimensioned to receive respective optical components such that the flanges press against and prevent the optical component from voluntary disengagement.

18. The laser head of claim 17, wherein the flanges of respective clips each have respective tip portions converging to one another so as to press upon a top of the inserted optical component.

19. The laser head of claim 17, wherein the bottom of each clip is configured with:
a protrusion extending from an outer side of the bottom and soldered to EO PCB, and
a pair of arms flanking the protrusion and soldered to the EO PCB, the protrusion and arms being soldered so that the clip yaws and tilts.

20. The laser head of claim 1 further comprising a plurality of output collimator assemblies guiding the light at the higher frequency outside the housing and a dump assembly guiding unconverted pump light outside the housing.
